(19) United States
(12) Patent Application Publication
(10) Pub. No.: US 2017/0043635 A1
(43) Pub. Date: Feb. 16, 2017

(54) Devices, Systems and Methods for Tire Removal

(71) Applicant: Performance Ag & Tool, LLC., Odebolt, IA (US)

(72) Inventors: John Scott, Odebolt, IA (US); Rick Sackett, Schaller, IA (US)

(21) Appl. No.: 15/234,583

(22) Filed: Aug. 11, 2016

Related U.S. Application Data
(60) Provisional application No. 62/203,764, filed on Aug. 11, 2015.

(51) Int. Cl. B60C 25/13

(52) U.S. Cl. CPC B60C 25/13

(57) ABSTRACT

The disclosed embodiments relate to various devices, systems and methods relating to a locking bead separator.

### CROSS-REFERENCE TO RELATED APPLICATION(S)

None. This application claims priority from U.S. Provisional Application No. 62/203,764, filed Aug. 11, 2015, and entitled “Devices, Systems and Methods for Tire Removal,” which is hereby incorporated by reference in its entirety under 35 U.S.C. §119(e).

### FIELD OF THE INVENTION

Disclosed herein are various devices, systems and methods relating to the automotive industry. More particularly, the disclosed embodiments relate to devices, systems and methods for use with tires and wheels.

### BACKGROUND OF THE INVENTION

There is a need in the art for improved devices, systems and methods for use in the changing of tires on rims.

### BRIEF SUMMARY OF THE INVENTION

The presently disclosed implementations relate to devices, systems and methods relating to wheels and tires, and more specifically, to a bead breaker and related systems and methods for removing a tire from a rim.

In one Example, a locking bead separator, including an actuator, an elongate, hollow main frame having proximal and distal ends and including a bead wedge disposed at the distal end, a center cleat disposed within the main frame including a bead drive disposed at the distal end, and a rim lock mechanism.

Implementations may include one or more of the following features. The locking bead separator where the actuator is configured to drive the center cleat distally. The locking bead separator further including a posi-lock. The locking bead separator where the rim lock mechanism is engaged by the posi-lock. The locking bead separator where the distal end of the frame includes first and second outer cleats. The locking bead separator further including a toe kick in operational communication with the rim lock mechanism. The locking bead separator further including a tongue. The locking bead separator further including an actuator configured to drive the center cleat distally. The locking bead separator where the rim lock is engaged by a toe kick. The locking bead separator where the posi-lock is configured to grasp a rim so as to dispose the bead drive adjacent to a tire bead. The locking bead separator where the posi-lock includes at least one axle and at least one bar. The locking bead separator where the posi-lock includes a tongue. The locking bead separator where the distal end of the frame includes first and second outer cleats. The locking bead system where the actuator is configured to drive the center cleat distally. The locking bead system where the rim lock is engaged by a toe kick. The locking bead system where the actuator is a pneumatic actuator. The locking bead system where the posi-lock includes at least one axle, at least one bar and a tongue. The locking bead system further including a handle disposed at the proximal end of the main frame.

In one Example, a locking bead separator, including an elongate, hollow main frame having proximal and distal ends and including a bead wedge disposed at the distal end, a center cleat disposed within the main frame including a bead drive disposed at the distal end, and a rim lock including a posi-lock.

Implementations may include one or more of the following features. The locking bead separator where the rim lock is engaged by a toe kick. The locking bead separator where the posi-lock is configured to grasp a rim so as to dispose the bead drive adjacent to a tire bead. The locking bead separator where the posi-lock includes at least one axle and at least one bar. The locking bead separator where the posi-lock includes a tongue. The locking bead separator where the distal end of the frame includes first and second outer cleats. The locking bead system where the actuator is configured to drive the center cleat distally. The locking bead system where the rim lock is engaged by a toe kick. The locking bead system where the actuator is a pneumatic actuator. The locking bead system where the posi-lock includes at least one axle, at least one bar and a tongue. The locking bead system further including a handle disposed at the proximal end of the main frame.

In one Example, a locking bead system, including an elongate, hollow main frame having proximal and distal ends and including a bead wedge disposed at the distal end, an elongate center cleat disposed within the main frame, the center cleat including a bead drive disposed at the distal end of the frame, an actuator in driving communication with the center cleat, and a rim lock including a posi-lock, where the rim lock is configured to grasp a rim such that the bead drive is positioned to break a tire bead seal.

Implementations may include one or more of the following features. The locking bead system where the actuator is configured to drive the center cleat distally. The locking bead system where the rim lock is engaged by a toe kick. The locking bead system where the actuator is a pneumatic actuator. The locking bead system where the posi-lock includes at least one axle, at least one bar and a tongue. The locking bead system further including a handle disposed at the proximal end of the main frame.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a side view depicting a bead breaker, according to one embodiment.

FIG. 1B is a further side view of the bead breaker of FIG. 1A.

FIG. 1C is an endlong view of the bead breaker of FIG. 1A.

FIG. 1D is a schmeatic interior view of the implementation of FIG. 1A.

FIG. 2A is a perspective side view of the bead breaker, according to a further implementation.

FIG. 2B is a disassembled perspective side view of the bead breaker of FIG. 2A.

FIG. 2C is a close-up side view of the distal end of the bead breaker of FIG. 2A.

FIG. 3A is a side perspective view of a bead breaker attached to a rim, according to one embodiment.

FIG. 3B is a close-up side view of the rim lock, according to the implementation of FIG. 3A.

FIG. 3C is another side view of the implementation of FIG. 3A, showing the rim lock grasping a rim and the distal end of the frame adjacent to a tire, ready to break the seal.

FIG. 4 is a perspective side view of the implementation of FIG. 3C after the seal has been broken.

### DETAILED DESCRIPTION

Certain embodiments of the disclosed devices, systems and methods relate to a locking bead separator or “bead breaker” for removing a tire bead from a tire rim. In various implementations, the bead breaker can be used to quickly and easily separate a tire from a rim. As described herein, the bead breaker is able to quickly lock onto a rim and drive a center cleat into the tire to break the bead connection. In various implementations, a posi-lock design is provided which allows for quick clasping of the bead breaker to the rim, and a pneumatic actuator is then able to drive the cleat into the tire to break the bead seal.

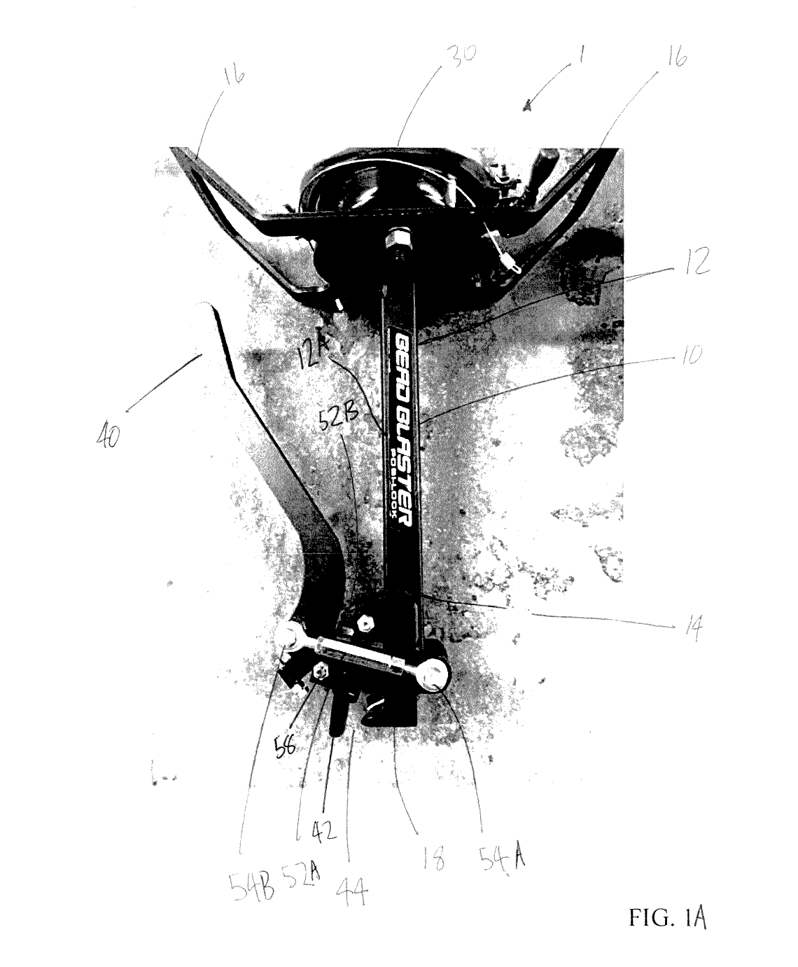

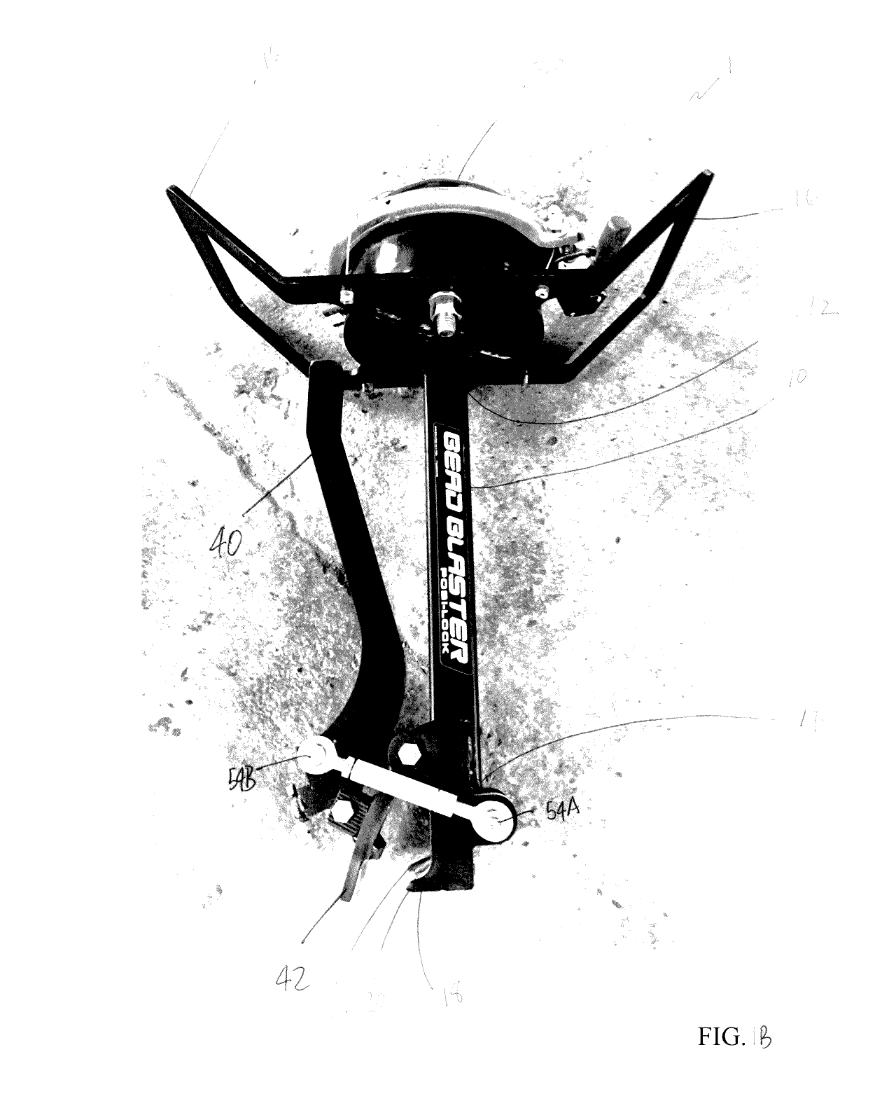

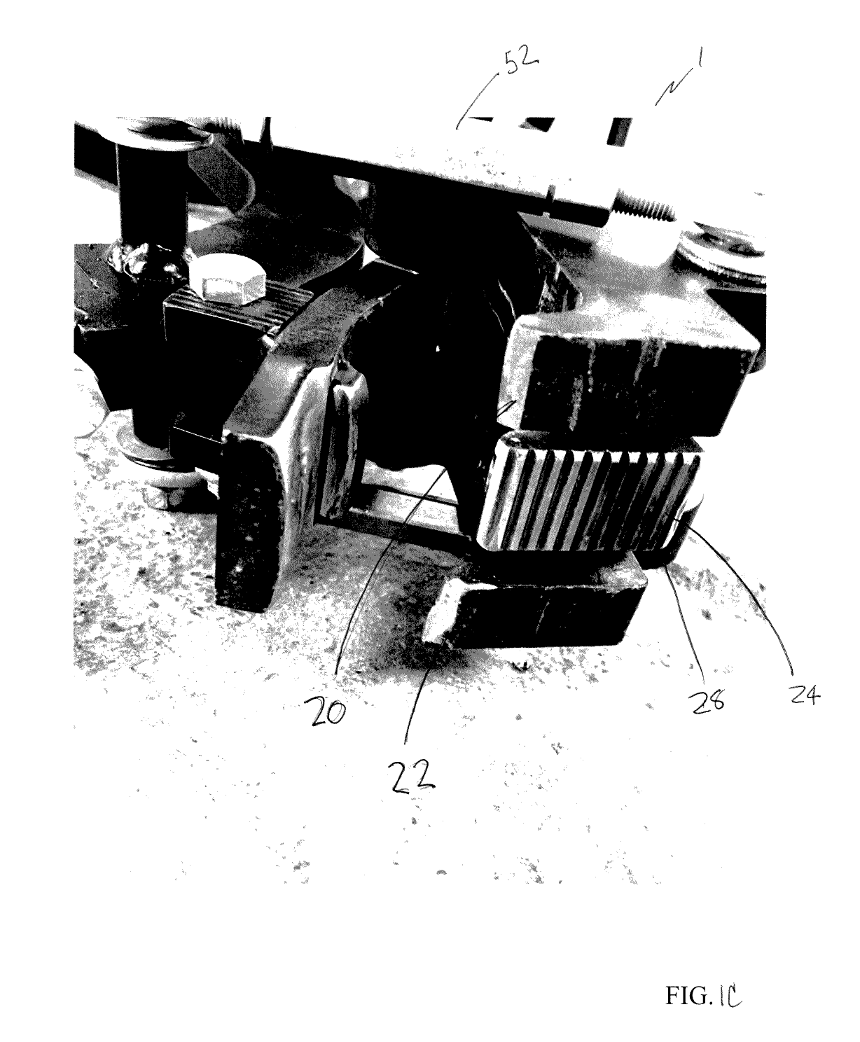

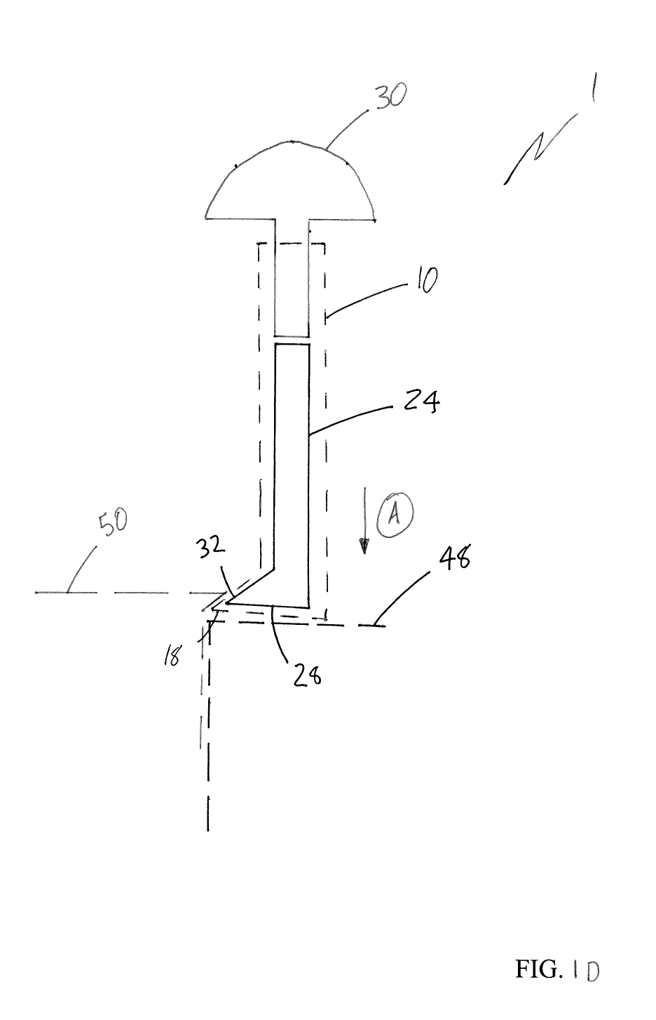

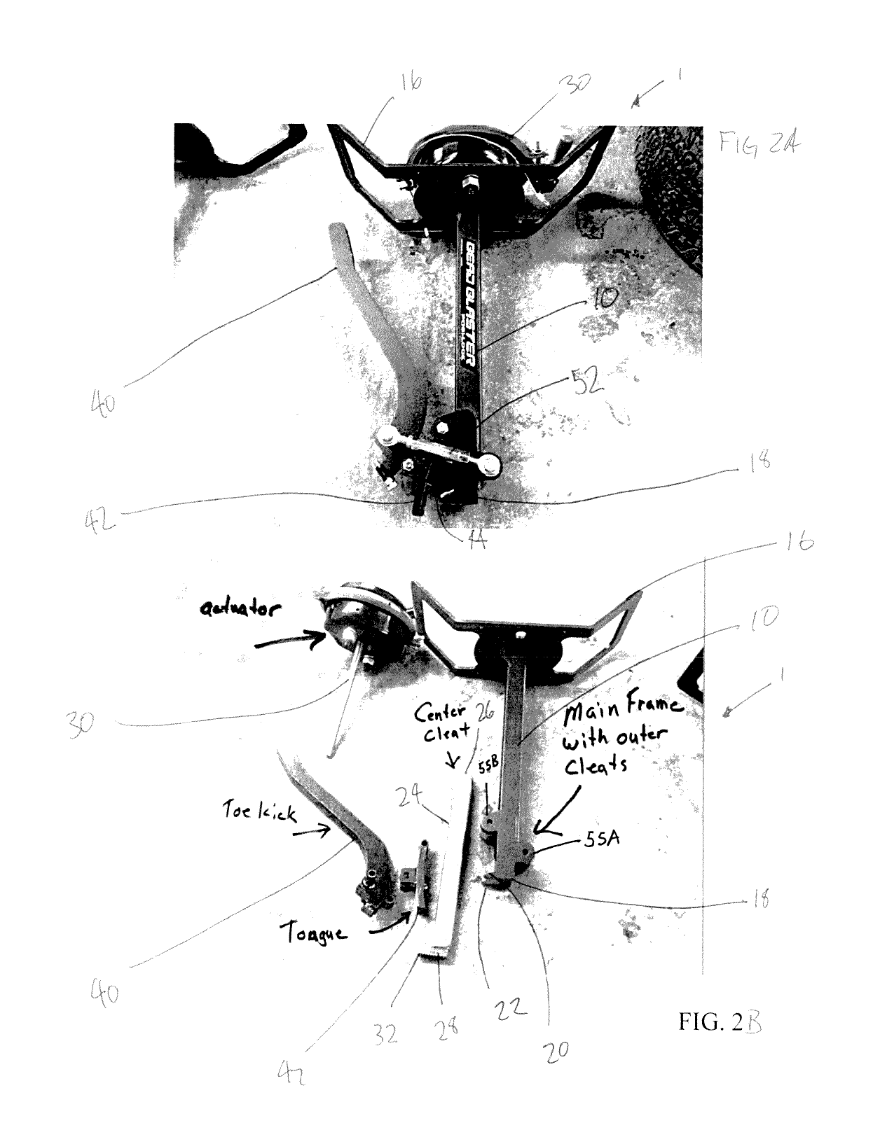

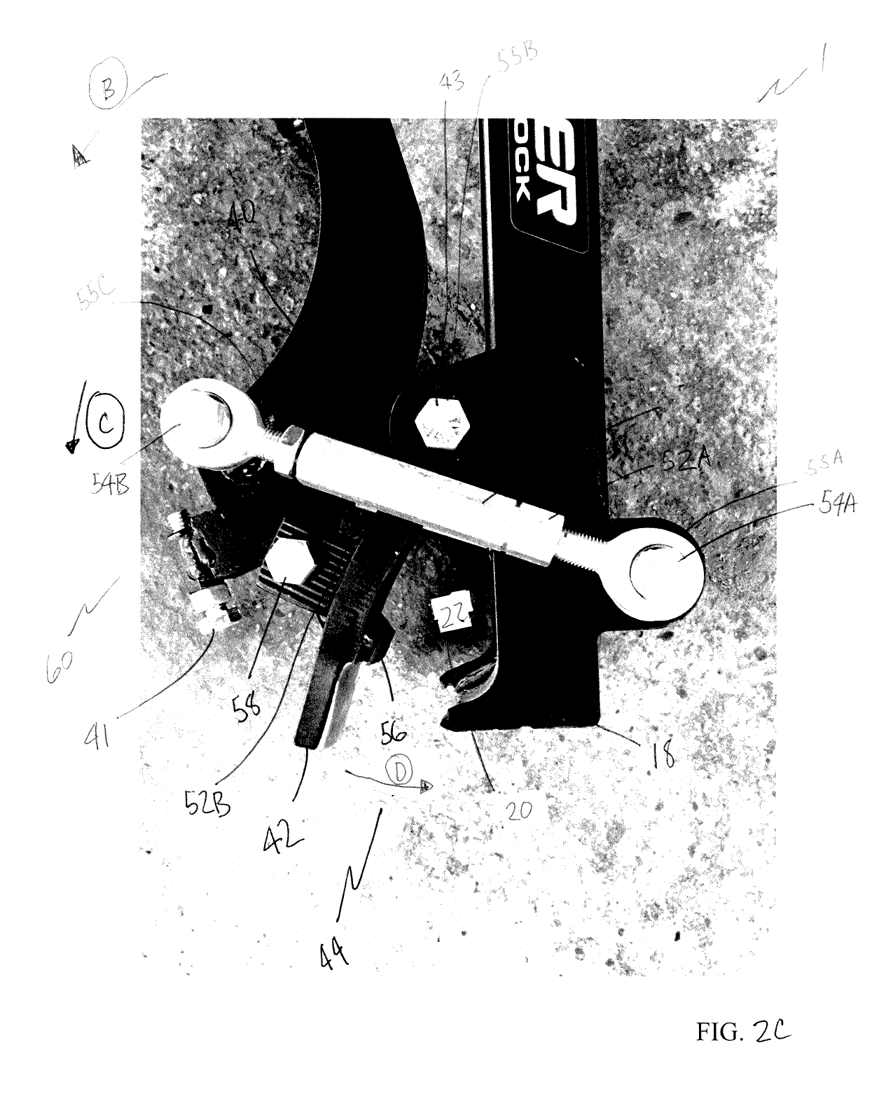

Turning to the figures in greater detail, as best shown in FIGS. 1A-1D, certain implementations of the bead breaker 1 have an elongate mast or frame 10 having a first, proximal end 12 and a second, distal end 14 and a handle 16 disposed at the proximal end 12. In these implementations, the frame 10 can be generally U-shaped, so as to be open on one side 12A. It is understood that other implementations are possible. As described further in relation to the implementations of FIGS. 2A-C, at the distal end 14, a rim lock 44 can provided, and can be actuated by the handle or toe kick 40 to grasp a rim. As best shown in FIG. 1C, center cleat 24 is disposed at the distal end 14.

The center cleat is in operational communication with an actuator 30, so as to be forcibly urged downward as shown in FIG. 1D by reference arrow A), so as to break the seal between a rim 50 and a tire 48. In certain implementations, the actuator 30 is pneumatically-driven, such that a pneumatic force exerted by the actuator 30 can drive the center cleat 24 downward to quickly remove the tire 48 by way of the center cleat 24 and bead drive 32. Other implementations are possible.

Continuing with the implementation of FIGS. 1A-C, the frame 10 further comprises a bead wedge 18 disposed at the distal end 14. As best shown in FIG. 1C, the bead wedge 18 can have first 20 and second 22 outer cleats, with a center cleat 24 adapted to fit within the main frame 10. In these implementations, and as best shown in FIG. 2B, the center cleat center has first, or proximal cleat end 26 and a second, or distal cleat end 28. Returning to the implementation of FIGS. 1A-C, an actuator 30 is also provided, which is in operational communication with the proximal cleat end 26, as is described herein.

As best shown in the implementations of FIGS. 2A-C, a bead drive 32 of a similar wedge shape to the bead wedge 18 and is disposed at the distal cleat end 28, so as to be capable of being substantially aligned with the bead wedge 18.

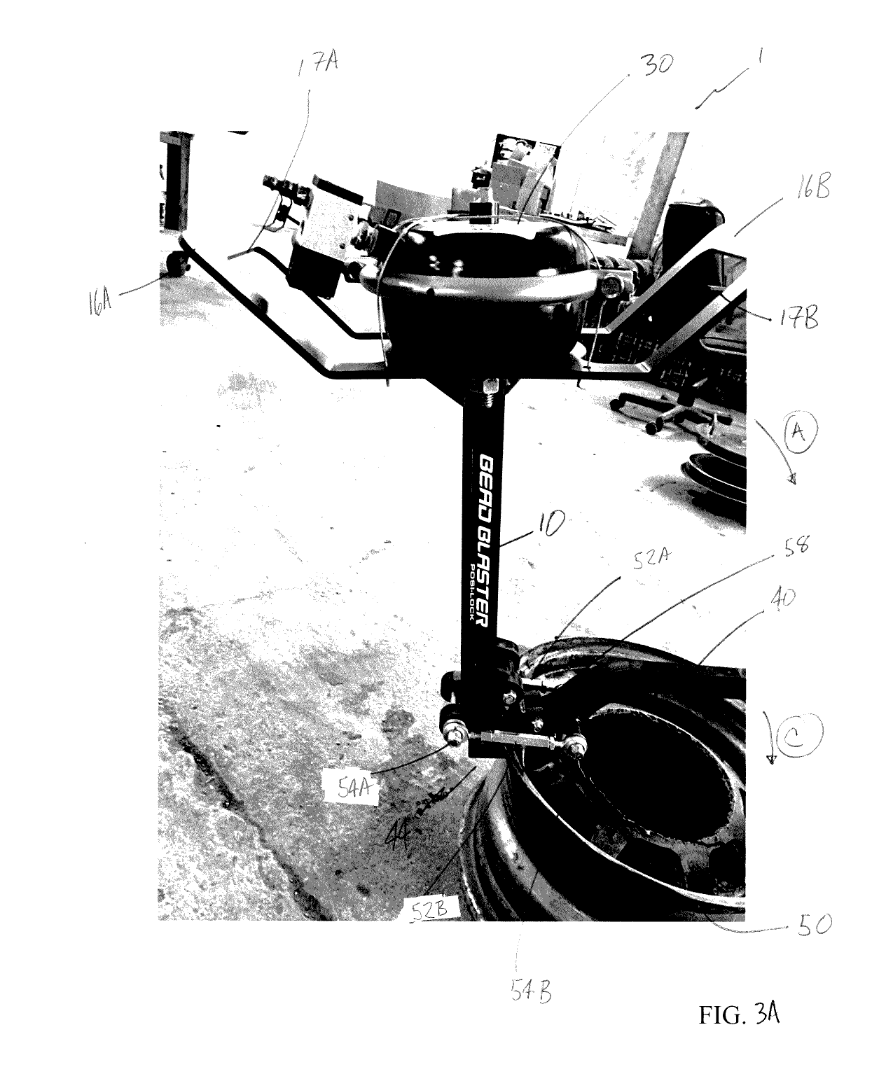

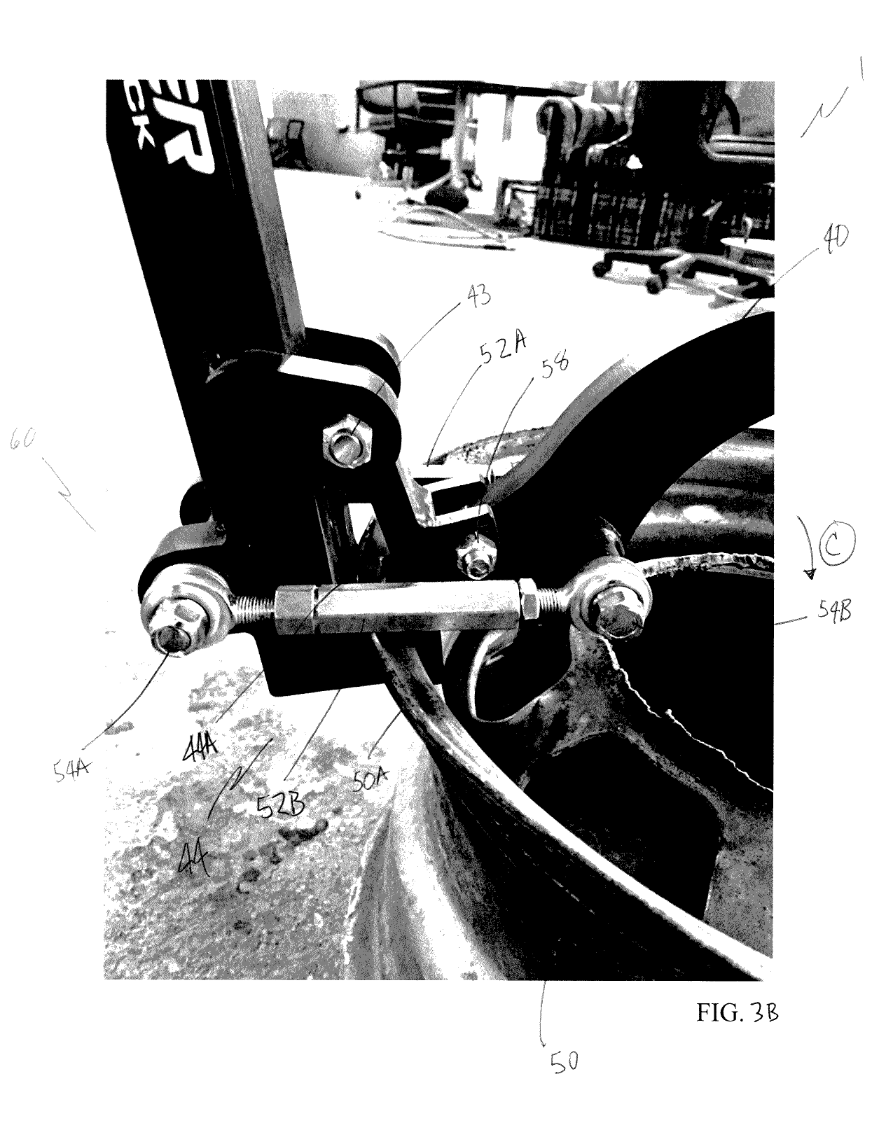

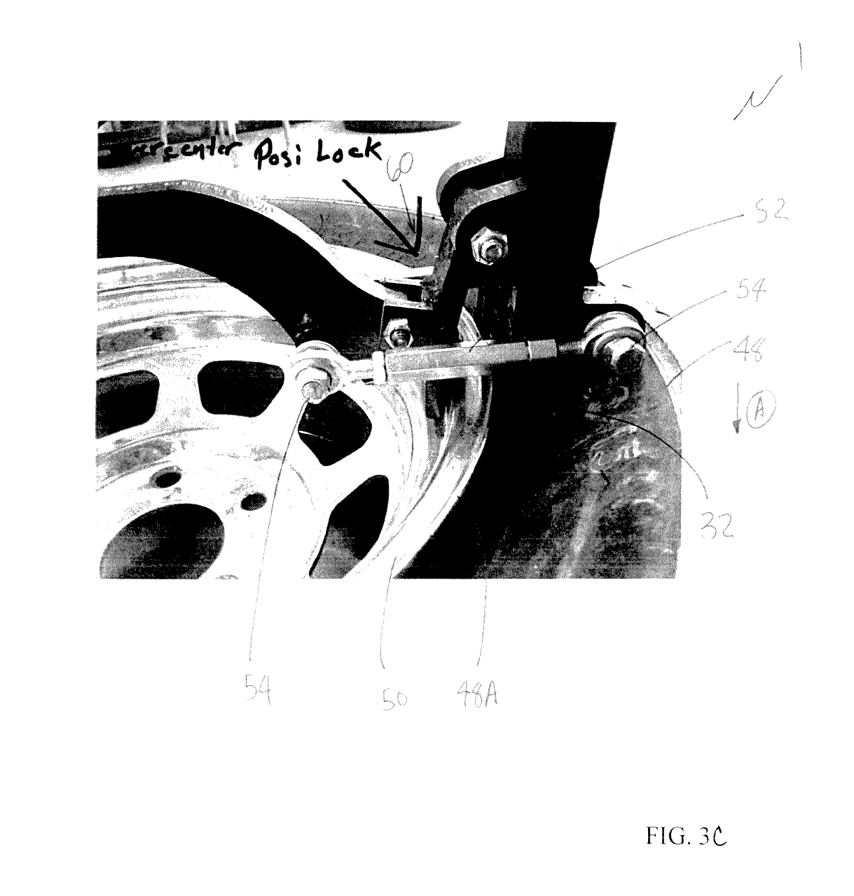

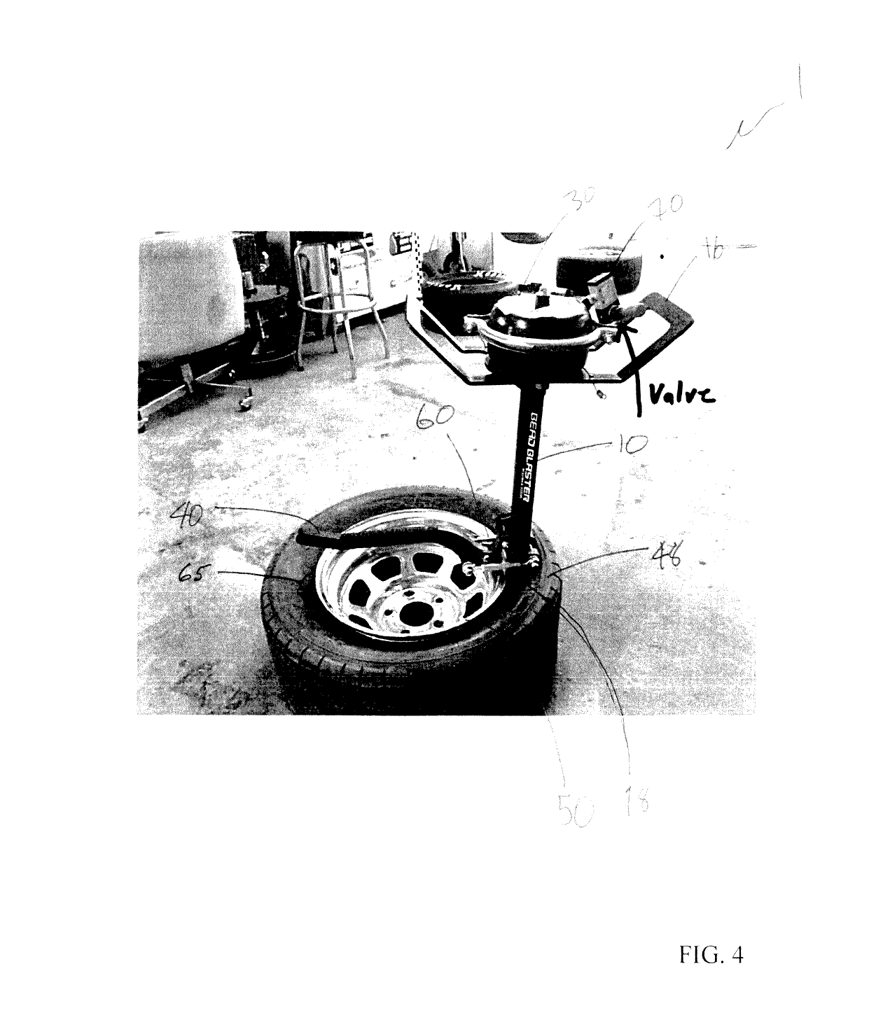

As is shown in the implementation of FIG. 2B, the center cleat 24 and tongue 42 are disposed between an elongate handle or “toe kick” 40 and the main frame 10 so as to form the rim lock 44, which is capable of being coupled to a tire and rim assembly (shown in FIGS. 3 at 48 and 50, respectively). As is also described in relation to FIGS. 3A-B, in certain embodiments, the rim lock 44 operates so as to hold the bead breaker 1 in fixed state, so that the center cleat's 24 bead drive 32 can be forced between the rim 50 and tire 48 at the tire bead 48A by way of the actuator, so as to break the seal and separate the tire 48 from the rim 50, as would be apparent to one of skill in the art. In certain embodiments, the size of each of these components can be varied so as to accept different wheel styles.

As best shown in FIG. 2C, in certain embodiments, the bead breaker 1 further comprises a posi-lock mechanism 60 integrated into the a toe kick 40 and tongue 42 which allows the toe kick 40 and rim lock 44 to come to a locked position by way of an “over-centering” action, as would be apparent to one of skill in the art. Namely, in these implementations, the toe kick 40 is in rotational communication relative to the frame 10 by way of the posi-lock 60, which includes a tongue pivot 58, least one bar 52A, 52B and paired axles 54A, 54B and mounted on mounting points 55A, 55B, 55C disposed on either side of the rim lock 44. In these implementations, the first axle 54A is disposed within the first mounting point 55A, the tongue pivot 43 is disposed within a second mounting point 55B, and the second axle is 54B is disposed within the third mounting point 55C.

In use, a user is able to apply leveraged pressure to the tongue 42 by rotating the toe kick 40 (as shown by reference arrow B) so as to urge the tongue 42 into position: toward the distal end 14 of the frame 10 by way of the tongue pivot 43 (as is shown by reference arrow D). This motion engages the rim lock 44 around a rim (as is shown in FIGS. 3A-B, where the rim lock 44 is “locked” on the rim 50 such that the rim lip 50A is contained within the rim lock opening 44A). In certain implementations, and as best shown in FIG. 2C, the toe kick 40 has a tongue contact 41 disposed at the distal end to provide additional grip on the rim 50, as would be understood by one of skill in the art.

The movement of these components constitutes the posi-lock 60. In the depicted embodiment of FIG. 2C, the assembled bead breaker 1 further comprises at least one bar 52A, 52B which can be disposed on either side of the frame between paired axles 54A, 54B on either side of the rim lock 44, so as to allow controlled movement of the bars 52A, 52B and second axle 54B (as shown at reference arrow C) and the tongue 42 relative to the bead wedge 18 in response to a swinging “out and down” motion of the toe kick 40 from the main frame 10. This out and down action allows the locking of the bead breaker 1 to the rim (as shown in FIG. 3A). It is understood that other configurations for providing a selective rim lock 44 configured to grasp a rim and position the center cleat 24 for breaking the bead are of course possible.

As is also shown in FIG. 2C, in these implementations the tongue 42 further comprises a rim grasping protrusion 56, which is configured to correspond to the first and second outer cleats 20, 22 to selectively grasp the rim when the toe kick 40 is rotated away from the frame 10 and into position, such that that bead wedge 18 is placed between the rim 50 and tire. In these implementations, a tongue pivot 58 is disposed between the tongue 42 and toe kick 40, so as to be in mechanical communication with the bars 52A, 52B and paired axles 54A. Further, in these implementations, and as shown in FIG. 3A-B, the downward motion of the toe kick 40 also urges the toe kick side bolt 54B downward relative to the frame 10, such that in certain implementations it is moved from being “above” the tongue pivot 58 in the open position (as shown, for example in FIG. 1A) to “below” the tongue pivot 58 in the closed or locked position, as is shown in FIG. 3B.

In various embodiments, and as best shown in FIG. 3C and 1D, the pneumatic actuator 30 serves to force the center cleat 24 to extend the bead drive 32 past the bead wedge and into the tire 48, while the outer cleats 20, 22 hook the rim 50 thus forcing the tire bead 48A off the rim 50 (as shown by reference arrow A). In certain implementations, the actuator 30 is pneumatically-driven, such that a combination of pneumatic force by way of the actuator 30 and mechanical pressure exerted by way of the toe kick and tongue can be used to lock to the rim 50 and quickly remove the tire 48 by way of the center cleat and bead drive 32. In use, as would be apparent to one of skill in the art, the user can work the bead breaker 1 around the lip 50A of the rim 50 in a circular fashion by way of the handle region 16. As is also shown in the implementation of FIG. 3A, the handle 16 can comprise angled portions 16A, 16B and hand holes 17A, 17B to facilitate the placement and movement of the bead breaker 1.

As is shown in FIG. 4, after the center cleat 24 has been driven through the tire 48 seal, the bead will be broken such that the rim 50 and tire are separated, as designated by gap 65. In exemplary embodiments, the bead breaker 1 actuator 30 has a valve 70. One skilled in the art will appreciate that different pressures can be used to power the actuator 30. In one example, the actuator 30 is pneumatically actuated at about 127 psi. Other pressures can be used, as would be apparent to one of skill in the art.

Although the disclosed devices, systems and methods have been described with reference to certain embodiments, persons skilled in the art will recognize that changes may be made in form and detail without departing from the spirit and scope of the disclosure.

What is claimed is:

1. A locking bead separator, comprising:
a. an actuator;
b. an elongate, hollow main frame having proximal and distal ends and comprising a bead wedge disposed at the distal end;
c. a center cleat disposed within the main frame comprising a bead drive disposed at the distal end; and
d. a rim lock mechanism.

2. The locking bead separator of claim 1, wherein the actuator is configured to drive the center cleat distally.

3. The locking bead separator of claim 1, further comprising a posi-lock.

4. The locking bead separator of claim 3, wherein the rim lock mechanism is engaged by the posi-lock.

5. The locking bead separator of claim 1, wherein the distal end of the frame comprises first and second outer cleats.

6. The locking bead separator of claim 1, further comprising a toe kick in operational communication with the rim lock mechanism.

7. The locking bead separator of claim 1, further comprising a tongue.

8. A locking bead separator, comprising:
a. an elongate, hollow main frame having proximal and distal ends and comprising a bead wedge disposed at the distal end;
b. a center cleat disposed within the main frame comprising a bead drive disposed at the distal end; and
c. a rim lock comprising a posi-lock.

9. The locking bead separator of claim 1, further comprising an actuator configured to drive the center cleat distally.

10. The locking bead separator of claim 8, wherein the rim lock is engaged by a toe kick.

11. The locking bead separator of claim 8, wherein the posi-lock is configured to grasp a rim so as to dispose the bead drive adjacent to a tire bead.

12. The locking bead separator of claim 8, wherein the posi-lock comprises at least one axle and at least one bar.

13. The locking bead separator of claim 8, wherein the posi-lock comprises a tongue.

14. The locking bead separator of claim 8, wherein the distal end of the frame comprises first and second outer cleats.

15. A locking bead system, comprising:
a. an elongate, hollow main frame having proximal and distal ends and comprising a bead wedge disposed at the distal end;
b. an elongate center cleat disposed within the main frame, the center cleat comprising a bead drive disposed at the distal end of the frame;
c. an actuator in driving communication with the center cleat; and
d. a rim lock comprising a posi-lock,
wherein the rim lock is configured to grasp a rim such that the bead drive is positioned to break a tire bead seal.

16. The locking bead system of claim 15, wherein the actuator is configured to drive the center cleat distally.

17. The locking bead system of claim 15, wherein the rim lock is engaged by a toe kick.

18. The locking bead system of claim 15, wherein the actuator is a pneumatic actuator.

19. The locking bead system of claim 15, wherein the posi-lock comprises at least one axle, at least one bar and a tongue.

20. The locking bead system of claim 15, further comprising a handle disposed at the proximal end of the main frame.
